(19) United States
(12) Patent Application Publication
(10) Pub. No.: US 2025/0391012 A1
(43) Pub. Date: Dec. 25, 2025

(54) MULTIFUNCTIONAL SYSTEMS FOR ELECTRONIC DEVICES AND METHODS

(71) Applicant: UNIVERSIDAD DE LAS PALMAS DE GRAN CANARIA, LAS PALMAS DE GRAN CANARIA (ES)

(72) Inventors: AURELIO VEGA MARTÍNEZ, LAS PALMAS DE GRAN CANARIA (ES); CARLOS VEGA GARCÍA, LAS PALMAS DE GRAN CANARIA (ES)

(21) Appl. No.: 18/879,139

(22) PCT Filed: Jun. 27, 2023
(86) PCT No.: PCT/EP2023/067451

§ 371 Date: Dec. 26, 2024

(30) Foreign Application Priority Data
Jun. 28, 2022 (EP) 22382607.4

(51) Int. Cl. G06T 7/00; G06T 7/11; G06V 10/764

(52) U.S. Cl. CPC G06T 7/001; G06T 7/0008; G06T 7/11; G06V 10/764; G06T 2207/20081; G06T 2207/20084; G06T 2207/30141; G06V 2201/07

(57) ABSTRACT

A multifunctional system for electronic devices, including a main frame to removably receive an auxiliary frame. The auxiliary frame is configured to support the electronic device. The system further includes a controller to receive a first image and a head assembly having a tool in data communication with the controller. The controller is configured to generate first copies of the first image, to apply a neural network for detecting electronic components based on the first copies and determine presence and position of an electronic component. A method for operating a multifunctional system is also provided.

The present application claims the benefit and priority of EP22382607, filed on Jun. 28, 2022.

The present disclosure relates to multifunctional systems for electronic devices, and methods for operating the systems.

### BACKGROUND

Electronic circuits and electronic components are electronic devices that are widely used in several fields. Particularly, an electronic circuit usually has a series of electrical or electronic components which are connected with each other to generate, carry and modify electronic signals. A printed circuit board (PCB) provides physical support for the components and includes electrical connections among the components.

Usually, the PCB with the installed components is inspected for detecting failures. Inspection can be performed during manufacturing or during PCB repair.

Simple or high-production PCB layouts allow mounting, soldering and/or inspection tasks to be standardised, either manually or automatically. This means that operation is relatively simple to carry out. However, the current trend in PCB manufacturing involves increasingly complex and purpose-specific layouts. This may mean that several electronic circuit designs are produced at the same site, and with relatively small production runs. A relatively short series of electronic circuits may not have a predetermined operation plan. This may complicate the tasks to be performed on the PCBs.

In the case of repair or recovery of PCBs in service, there is usually no information on the components and the inspection has to be done manually.

The present disclosure provides examples of systems and methods that at least partially resolve some of the aforementioned disadvantages.

### SUMMARY

In a first aspect, a multifunctional system for electronic devices is provided. The system comprises a main frame having a receiving portion to removably receive an auxiliary frame, the auxiliary frame comprising a supporting region to support the electronic device. The system comprises an image sensor configured to obtain a first image of at least a portion of the supporting region. Furthermore, the system comprises a controller configured to receive the first image obtained by the image sensor. The system comprises a driving arm configured to drive a head assembly over the supporting region, the head assembly having a tool in data communication with the controller; wherein the controller is configured to generate a plurality of first copies of the first image wherein at least one of the first copies has a different pixel density value than the rest of the first copies, apply a first neural network for detecting electronic components based on the first copies, and determine presence and position of an electronic component on the supporting region from the output of the first neural network.

According to this aspect, the auxiliary frame may be changed depending on the operation to be performed on the electronic device. This may provide a quick and easy solution to perform different tasks on the same station.

According to this aspect, the auxiliary frame may be changed to suit the PCB model to be operated. This may mean an enhanced flexibility.

The system of this aspect may involve an artificial intelligence-assisted workflow that may avoid having to configure the system by the user and allows it to be used by non-expert staff. The system may be used for design and manufacturing tasks, as well as for repairing tasks. A relatively easy operation of the system may be achieved.

The system according to this aspect may be used for reverse engineering a printed circuit board. This may be useful for generating the necessary documentation to repair boards that are not electronically documented. Components may be identified by the neural network and presence and position information of each component may be generated to obtain the layout in CAD tools.

In some examples of the system, the head assembly may comprise an electrical probe, and the controller may be configured to compute a layout of a printed circuit board from the output of the first neural network and determine a test to be performed on the printed circuit board by comparing the layout of the printed circuit board with pre-determined layouts and associated tests. The system according to this example, may be used for repairing a printed circuit board during manufacturing. A faulty component may be located by the processor and thus removed from the board.

The test to be performed may comprise a passive test, in which the printed circuit board is in a non-operative condition, or an active test, in which the printed circuit board is in an operative condition.

According to some examples, the auxiliary frame may comprise a dedicated device, the main frame having a main connector connectable to an auxiliary connector of the auxiliary frame, in such a way that an electrical connection may be achieved between the main connector and the auxiliary connector in a coupled position of the main frame and the auxiliary frame, the dedicated device being electrically connected to the auxiliary connector. This way, the auxiliary frame and its components may be fed and controlled by the controller. Furthermore, the controller may detect the type of auxiliary frame coupled to the main frame. The data about the type of auxiliary frame may be used to determine a particular operation to be performed on the board.

According to examples, the auxiliary frame may have a board connector to be connected to the printed circuit board and the board connector is electrically connected to the dedicated device. The auxiliary frame may have the necessary electrical connections to supply the PCB with power and/or an electronic signal.

In examples, the dedicated device may be an active testing circuit configured to feed the printed circuit board in an operation status with an input signal and to receive an output signal from the printed circuit board, and the controller is configured to control the active testing circuit. The dedicated device may comprise electronic circuitry to produce an input signal to the PCB and receive an output signal from the PCB.

The controller may be configured to implement a first neural network or deep learning algorithm for detecting electronic components.

In a further aspect, a method for operating a multifunctional system is disclosed. The method comprises capturing, by an image sensor, a first image of at least a portion of a supporting region configured to support the electronic device. The method comprises generating, by a controller, a plurality of first copies of the first image, wherein at least one of the first copies has a different pixel density value than the rest of the first copies.

The method also comprises partitioning, by the controller, each of the first copies into cut-outs of predetermined size, and applying, by the controller, a first neural network to each of the cut-outs for detecting and classifying electronic components. Moreover, the method comprises determining, by the controller, presence and position of an electronic component on the supporting region from the output of the first neural network applied to each of the first cut-outs.

Advantages derived from this aspect may be similar to those mentioned regarding the previous aspect.

The method according to this aspect may allow to detect electronic devices such as electronic components, using relatively high-defined images and avoiding or reducing the need for high-performance computing devices.

Electronic components with the same classification and different dimensions may be identified by the method according to this aspect.

In examples, the method may comprise computing, by the controller, a layout of a printed circuit board from the output of the first neural network. The method comprises determining, by the controller, a test to be performed on the printed circuit board, by comparing the printed circuit board layout with pre-determined pattern layouts and associated tests, and operating, by the controller, a head assembly having an electrical probe to measure an electrical parameter or signal on an electronic component.

In examples, the method may comprise adjusting the pixel density value of a first copy based on a size of an expected electronic component to be detected. In some examples, the method may comprise adjusting the pixel density value of a first copy in such a way that the size of the expected electronic component to be detected is within the range from ⅛ to 1/425 of the overall area of a single partition of a first copy.

According to these examples, the method may allow the pixel density to be adapted according to the type of object or component to be detected. For example, for objects of significantly larger size, the algorithm or neural network may be run with a lower pixel density at the input.

In a further aspect, a method for training a first neural network of a method for operating a multifunctional system for electronic devices according to any of the examples disclosed herein, is disclosed. The method for training comprises providing a set of training cut-outs of training first copies, wherein the training cut-outs are of a predetermined size, the size referring to a number of pixels. The method further comprises training the first neural network with the set of training cut-outs with an associated classification label.

In the present disclosure, the terms PCB o printed circuit board are used interchangeably.

In the present disclosure, the term electronic device may comprise at least one of printed circuit board and electronic component.

PCB, as used herein, may be understood to encompass a board and the electrical and/or electronic components installed therein.

The expression pixel density value may refer to an amount of pixels per unit area.

Throughout the present disclosure, expressions such as above, below, beneath, under, upper, top, bottom, lower, downward, upward, forward, backward etc are to be understood taking into account the construction of a system or the like in an operating condition as a reference.

### BRIEF DESCRIPTION OF THE DRAWINGS

Non-limiting examples of the present disclosure will be described in the following, with reference to the appended drawings, in which:

FIG. 1 schematically illustrates a perspective view of a system according to one example of the present disclosure in a coupled position;

FIG. 2 schematically illustrates a perspective view of the system of FIG. 1 having an auxiliary frame in a detached position;

FIG. 3 schematically illustrates a perspective view of a system according to one example of the present disclosure in a coupled position;

FIG. 4 schematically illustrates a perspective view of the system of FIG. 3 having the auxiliary frame in a detached position;

FIGS. 5-7 schematically illustrates perspective view of auxiliary frames according to examples of the present disclosure;

FIG. 8 schematically illustrates a view from above of a main frame and an auxiliary frame according to an example of the present disclosure in a detached position;

FIG. 9 schematically illustrates a view from above of the main frame and the auxiliary frame of FIG. 8 in a coupled position;

FIG. 10 schematically illustrates a view from above of a main frame according to one example of the present disclosure;

FIG. 11 schematically illustrates a side view of the main frame of FIG. 10;

FIG. 12 schematically illustrates a view from above of an auxiliary frame according to one example of the present disclosure;

FIG. 13 schematically illustrates a side view of the auxiliary frame of FIG. 12;

FIG. 14 schematically illustrates a non-transitory machine-readable storage medium with a controller according to an example of the present disclosure;

FIG. 15 is a flow chart schematically illustrating a method for operating according to an example of the present disclosure;

FIG. 16 is a flow chart schematically illustrating a neural network and its input and output according to an example of the present disclosure;

FIG. 17 is a flow chart schematically illustrating a computer-implemented method according to an example of the present disclosure; and

FIG. 18 is a flow chart schematically illustrating a computer-implemented method according to an example of the present disclosure.

### DETAILED DESCRIPTION OF EXAMPLES

In these Figures, the same reference signs have been used to designate matching elements.

An X, Y, Z coordinate axis has been included in the attached figures. The arrangement of the axis has been chosen for the sake of clarity.

The examples of methods disclosed herein are not constrained to a particular order.

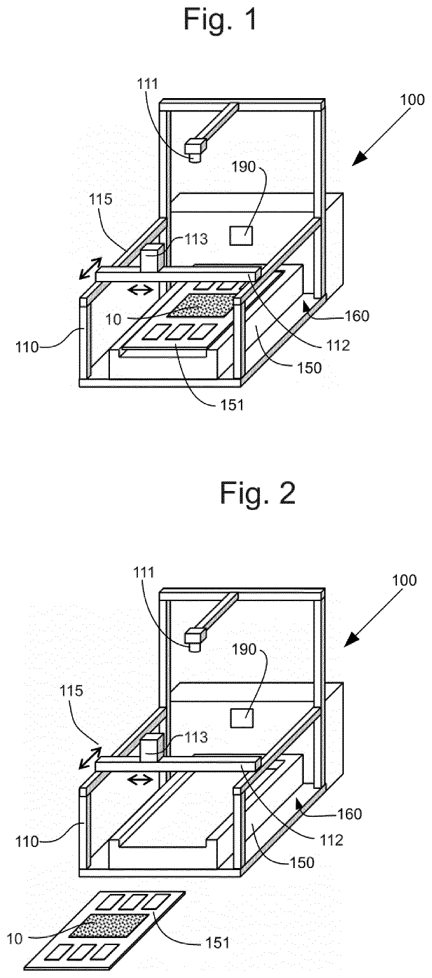

FIG. 1 schematically illustrates a perspective view of a system 100 according to one example of the present disclosure in a coupled position. Particularly, FIG. 1 illustrates a multifunctional system 100 for operating or performing tasks on a printed circuit board 10 and/or electronic components. The system 100 comprises a main frame 110 that has a receiving portion 160 to removably receive an auxiliary frame 150. The auxiliary frame 150 comprises a supporting region 151 configured to support the printed circuit board 10 and/or electronic components. In FIG. 1, the main frame 110 and the auxiliary frame 150 are shown in a coupled position while in FIG. 2 the auxiliary frame 150 is in a detached position from the main frame 110.

The system 100 may be used as a table-top system or installed in a rack.

As illustrated in FIGS. 1 and 2, the receiving portion 160 comprises a main room to removably receive the auxiliary frame 150. The auxiliary frame 150 may be shaped to fit, at least partially, the main room. The auxiliary frame 150 may enter and be removed from the main room through the same side of the main frame 110, such as a front side.

The auxiliary frame 150 may have a generally drawer-like construction. In examples, the auxiliary frame 150 may be generally rectangular shaped when seen from above and having a bottom wall and side walls.

The system 100 comprises an image sensor configured to obtain a first image of at least a portion of the supporting region 151. Furthermore, the system 100 also comprises a controller 190 that is configured to receive the first image obtained by the image sensor. The portion of the supporting region 151 may include, at least, a portion of the printed board circuit and/or the electronic component.

The image sensor may comprise an overhead camera 111 to capture the supporting region 151 and a head camera to capture a portion of the supporting region 151. The head camera may be located in a head assembly 113.

In FIG. 1, the system 100 comprises a driving arm 112 configured to drive the head assembly 113 over the supporting region 151. In the illustrated examples, the driving arm 112 comprises a linear drive. However, the driving arm 112 may comprise a robotic arm or the like. Owing to the linear drive, the head assembly 113 may move along the driving arm. The system 100 may comprise two guiding rails 115 parallel to each other, and each end of the linear drive may be slidably connected to each guiding rail. The linear drive may be displaceable along the guiding rails.

The head assembly 113 has a tool in data communication with the controller 190. By way of example, tools of head assemblies may include at least one of an electrical probe such as a flying probe configured to contact electrical components or parts of the printed circuit board 10 to perform electrical tests, a thermal sensor such as an infrared sensor configured to capture thermal images of the supporting region, an image sensor configured to capture images, a mounting tool to pick electronic components from trays and place them onto the board, a soldering tool configured to solder electronic components on the board. All the mentioned tools may be in data communication with the controller.

The auxiliary frame 150 may be sized such that the head assembly 113 is allowed to move and operate over the supporting region 151.

The controller 190 is configured to generate a plurality of first copies of the first image wherein at least one of the first copies has a different pixel density value than the rest of the first copies. The controller 190 is further configured to apply a first neural network for detecting electronic components based on the first copies and determine presence and position of an electronic component on the supporting region from the output of the first neural network. The electronic component may be on a tray or on the printed circuit board.

The first neural network may comprise a convolutional neural network. The neural network may be trained using training first copies with an associated classification label and/or position label. The same classification label may be associated to at least two different first copies. The first images or the first copies that may be used as input for the first neural network may comprise at least one of: a printed circuit board, an electronic component mounted on printed circuit board, an electronic component on the supporting region or the combination thereof.

In examples, the controller may be configured to compute a layout of a printed circuit board from an output of the first neural network and determine an operation to be performed on the printed circuit board supported by the supporting region, e.g. mounting an electronic component, soldering, unsoldering and/or testing. The head assembly 113 may have a suitable tool to perform the operation. The operation may be predetermined by the user or the type of auxiliary frame coupled to the main frame and detected by the controller.

In some examples, the head assembly 113 may comprise an electrical probe, and the controller may be configured to compute the layout of the printed circuit board from the output of the first neural network and determine a test to be performed on the printed circuit board 10 by comparing the layout of the printed circuit board with pre-determined layouts and associated tests. The controller may compare the with a list of predetermined layouts and computing a similarity score.

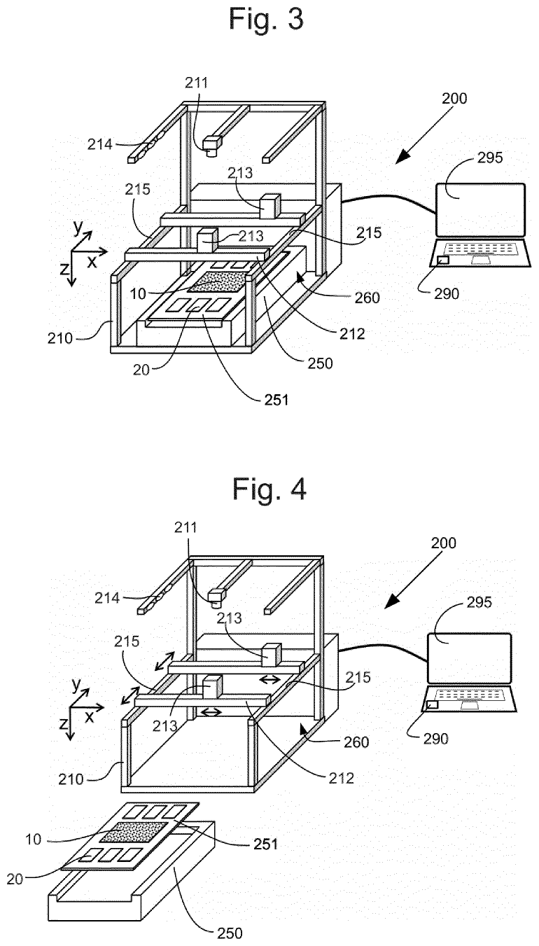

FIGS. 3 and 4 schematically illustrate perspective views of a system 200 according to one example of the present disclosure. In FIG. 3, the system 200 is illustrated in a coupled position, while in FIG. 4 the system 200 can be seen in a detached position. As in the example of FIG. 1, the auxiliary frame 250 is removably received by the main frame 210.

In the example of FIGS. 3 and 4, and particularly the coordinate axis, the Z axis represents a height or direction that may be followed by a head assembly 213 moving closer to or away from the supporting region 151. The Z axis may be related to an upward or downward direction followed by the head assembly or its tools. The X axis represents a width or direction that may followed by the head assembly moving along driving arm 212. The X axis may be related to a side-to-side direction, e.g., right side and left side followed by the head assembly or its tools. The Y axis represents a length or direction that may be followed by the driving arm 212 moving along guiding rails 215. The Y axis may be related to a forward direction or backward direction followed by the head assembly or its tools.

The system in the examples of FIGS. 3 and 4 comprises two driving arms. The controller may be configured to operate the driving arms not to interfere with each other. If each of the head assemblies comprises the electrical probe, each electrical probe may be placed on different locations over the printed circuit board 10 and an electrical test may be performed over a particular portion of the printed circuit board 10.

The supporting region in FIGS. 3 and 4 comprises a board bed 11 to receive the printed circuit board 10 and a tray 20 to receive the electronic component. The tray may be configured to receive electronic components randomly arranged on the tray. The first neural network may allow to locate the components regardless of their position and/or rotation.

The controller 290 in the example of FIGS. 3 and 4 is positioned in a computer 295 in data communication with the system 200. In this example, the controller 290 is positioned separate from the main frame 210. In the example of FIGS. 1 and 2, the controller 190 is positioned in the main frame 110. Other positions may be envisaged if the controller is in data communication with the rest of the system.

The computer 295 may have a graphical user interface (GUI) to allow the user to interact with the system according to the present disclosure. Outputs produced by the system or method as disclosed herein may be shown on the GUI. Inputs from the user may be entered through the GUI.

The system 200 may comprise light emitters 214 such as LED to illuminate areas of the supporting region to be captured as images.

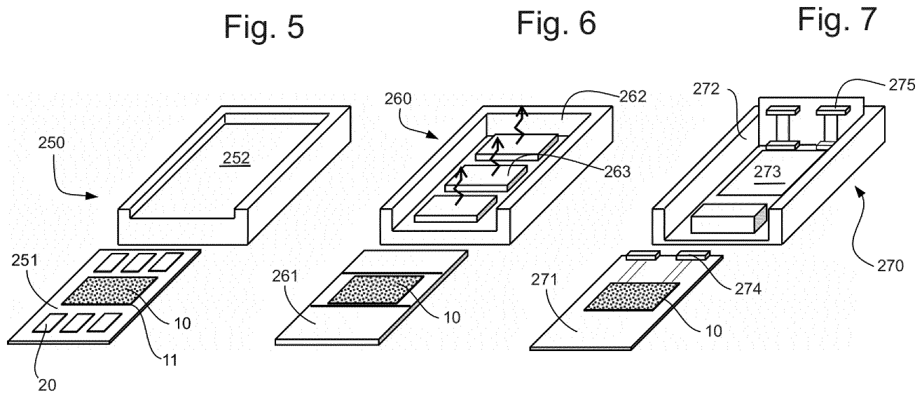

FIGS. 5-7 schematically illustrates perspective view of auxiliary frame 250, 260, 270 according to examples of the present disclosure. The examples of these FIGS. 5-7 comprise a supporting region 251, 261, 271 which is detachably mounted on the respective auxiliary frames 250, 260, 270. The supporting region 251, 261, 271 support the printed circuit board 10 and the trays 20 of electronic components. The supporting region 251, 261, 271 may be configured to fit or cover an auxiliary recess 252, 262, 272 of the supporting regions 251, 261, 271. In some examples, the supporting region 251, 261, 271 may be integrally formed with the auxiliary frame 250, 260, 270.

In some examples, depending on the layout of the printed circuit board 10, a particular supporting region 251, 261, 271 may be chosen. This may mean an enhanced flexibility.

The example of FIG. 5 comprises an auxiliary frame 250 similar to that one illustrated in FIG. 4. In this example, the auxiliary recess 252 is configured to substantially match the shape of the supporting region 251.

In the example of FIG. 6, the auxiliary recess 262 receives dedicated devices that comprise heaters 263 configured to apply heat to the supporting region 261 and thus the printed circuit board 10. This may be used before soldering an electronic component on the printed circuit board or unsoldering in case of repairing. The controller is configured to control the operation of the heater. In some examples, the system for inspecting may have the thermal sensor in such a way that the controller may have temperature data about the printed circuit board so as control activation of the heater 263. The supporting region 261 of FIG. 6 does not include trays to hold the electronic components, although it could include trays.

In the example of FIG. 7, the auxiliary recess 272 receives dedicated devices such as an active testing circuit 273. The auxiliary frame 270 of this example is provided with auxiliary connectors to feed the active testing circuit 273. The active testing circuit 273 may be configured to feed the printed circuit board 10 in an operation status with an input signal. The active testing circuit 273 may be configured to receive an output signal from the printed circuit board 10 as well. The controller may be configured to control the active testing circuit, for instance, operation of the active testing circuit.

Electrical supporting connector 274 and electrical base connector 275, may allow an electrical connection between the electronic or electrical devices on the supporting region 271 and the rest of the auxiliary frame 270, and thus a connection with the controller.

The examples of auxiliary frames 250, 260, 270 may be received by the main frame 210 because the auxiliary frames 250, 260, 270 are interchangeable. By way of example, the auxiliary frame 250 may be used for mounting electronic components on the printed circuit board. The auxiliary frame 260 may be used for soldering and/or unsoldering electronic components. The auxiliary frame 270 may be used for performing test on the printed circuit board. The test may be active or passive.

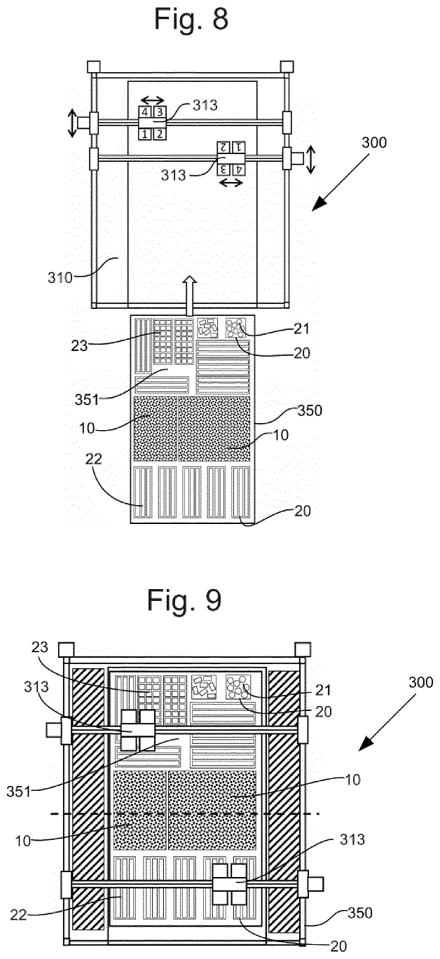

FIG. 8 schematically illustrates a view from above of a main frame 310 and an auxiliary frame 350 according to an example of the present disclosure in a detached position. FIG. 9 schematically illustrates a view from above of the main frame 310 and the auxiliary frame 350 in a coupled position.

In the examples of FIGS. 8 and 9, the supporting region 351 includes trays 20 with different electronic components 21, 22, 23 therein. Although in these Figures it has been depicted head assemblies 313 having several tools, the number of tools in each head assembly may vary.

In some examples, a tool or the head assembly may be displaceable along the Z axis and rotatable around the Z axis. An electric motor may drive the tool movement. The controller may control operation of the electric motor.

Numbers 1-4 shown in FIGS. 8 and 9 refer to different kinds of tools of the head assembly 313. In the example of FIGS. 8 and 9, the supporting region 351 may receive more than one PCBs.

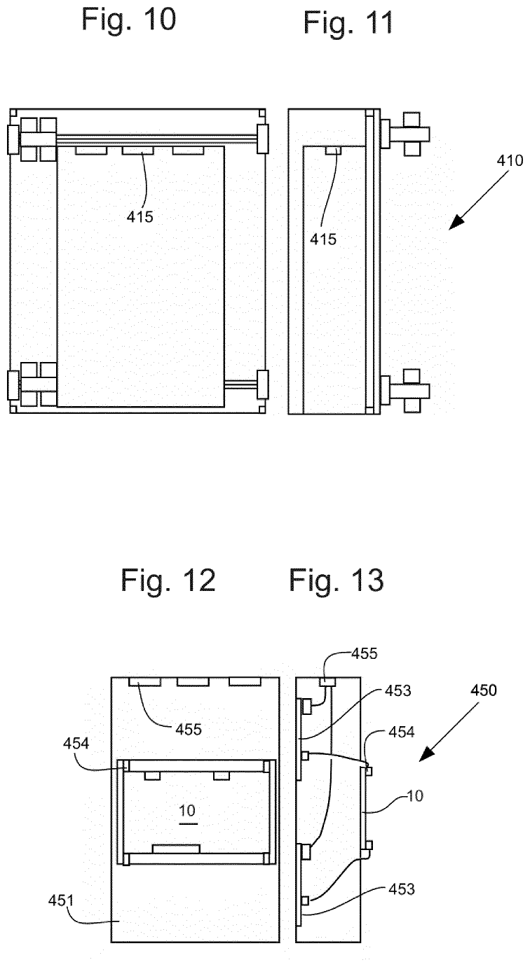

FIG. 10 schematically illustrates a view from above of a main frame 410 according to one example of the present disclosure, and FIG. 11 schematically illustrates a side view of the main frame 410 of FIG. 10. FIG. 12 schematically illustrates a view from above of an auxiliary frame 450 according to one example of the present disclosure, and FIG. 13 schematically illustrates a side view of the auxiliary frame 450 of FIG. 12.

In the examples of FIGS. 10 to 13, the auxiliary frame 450 comprises a dedicated device, and the main frame 410 has a main connector 415 connectable to an auxiliary connector 455 of the auxiliary frame 450, in such a way that an electrical connection is achieved between the main connector and the auxiliary connector in a coupled position of the main frame and the auxiliary frame. The dedicated device may be electrically connected to the auxiliary connector 455.

In the examples of FIGS. 7, 12 and 13, the auxiliary frame 270, 450 has a board connector 274, 454 to be connected to the printed circuit board 10 and the board connector 274, 454 is electrically connected to the dedicated device. The dedicated device in the examples of FIGS. 7, 12 and 13 comprises the active testing circuit 273, 453, although a passive test can be performed as well.

The supporting region 451, 271 of FIGS. 7, 12 and 13 may have dedicated fixtures for a PCB layout. Dedicated fixtures for the PCB layout and board connector 274, 454 may allow to perform an in-circuit testing (ICT).

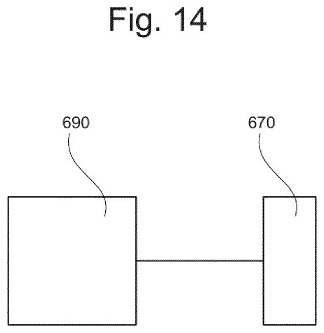

FIG. 14 schematically illustrates a non-transitory machine-readable storage medium with a controller according to an example of the present disclosure. The controller 690 may be a processor, a chip, a computational device or processing resources that executes sequences of machine-readable instructions contained in a memory. The controller 690 performs operations on data. The memory may be a non-transitory machine-readable storage medium 670. As can be seen in FIG. 14, the non-transitory machine-readable storage medium 670 is coupled to the processor 690. Examples of a non-transitory machine-readable storage medium may include a memory device, a floppy disk, a compact disk (CD), a digital versatile disk (DVD), a USB drive, a computer memory, a read-only memory or other devices that may store computer code.

The machine-readable instructions may comprise a computer program(s) in the form of source code, object code, a code intermediate source and object code such as in partially compiled form, or in any other form suitable for use in implementing the methods according to present disclosure.

The machine-readable instructions may be carried in a storage medium o may be carried in a transmissible carrier such as an electrical or optical signal, which may be conveyed via electrical or optical cable or by radio or other means.

The memory may store:
a database of predetermined layouts;
a test database of predetermined layouts and associated tests to be performed. The test may include instructions to obtain and processing data from the test;
a Gerber database comprising Gerber files of components;
a manufacturing database comprising instructions to manufacture PCB layouts.

Examples of methods for operating a multifunctional system according to the present disclosure are described below. Such methods may be performed with multifunctional systems for electronic devices disclosed herein.

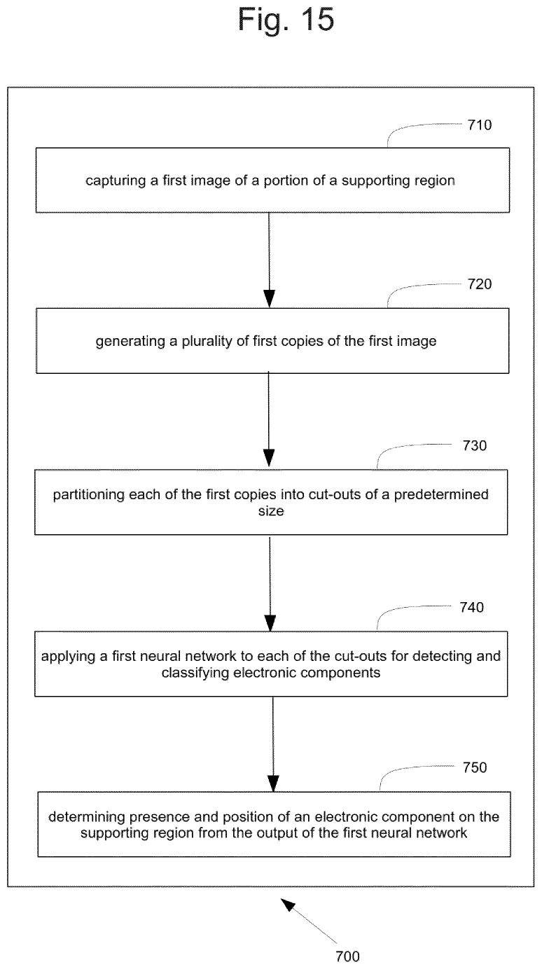

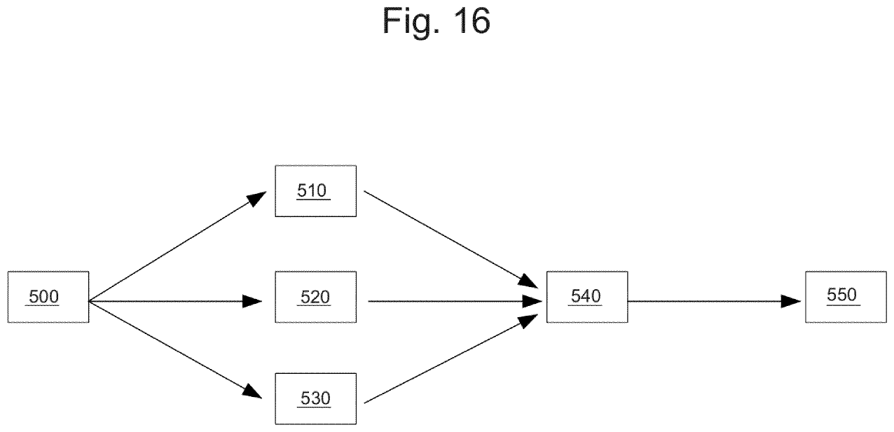

FIG. 15 is a flow chart schematically illustrating a method for operating according to an example of the present disclosure. And FIG. 16 is a flow chart schematically illustrating a neural network and its input and output according to an example of the present disclosure.

The method 700 for operating a multifunctional system comprises:
capturing 710, by an image sensor, a first image 500 of at least a portion of a supporting region configured to support the electronic device. The first image may be captured such that a predetermined distance is defined from an image sensor to the supporting region. The first image 500 may have a predefined number of dots per inch (DPI);
generating 720, by a controller, a plurality of first copies 510, 520, 530 of the first image, wherein at least one of the first copies has a different pixel density value than the rest of the first copies. The DPI of each first copy may be different from the rest of first copies;
partitioning 730, by the controller, each of the first copies into cut-outs of a predetermined size. In some examples, the predetermined size of the cut-outs may be 416×416 pixels. In some other examples, the predetermined size of the cut-outs may be 632×632 pixels. The predetermined size may also be set depending on the maximum or minimum size of the expected component to be detected;
applying 740, by the controller, a first neural network 540 to each of the cut-outs for detecting and classifying electronic components. The first neural network 540 may be trained with a set of training first copies with an associated classification label;
determining 750, by the controller, presence and position of an electronic component on the supporting region from the output 550 of the first neural network applied to each of the first cut-outs. The output 550 may comprise a combination of the results obtained with all the first copies. The results may be arranged with respect to the dimensions of the first image, namely detected components positioned on the first image.

In some examples, the method may comprise adjusting the pixel density value of a first copy based on a size of an expected electronic component to be detected. The maximum and minimum component size to be identified may be set. In examples, the adjustment of the pixel density values for the first copies may depend on the minimum and maximum area of an expected component to be detected. The size of an electronic device may refer to its area seen from above.

The method 700 may comprise adjusting the pixel density value of a first copy in such a way that the size of the expected electronic component to be detected is within the range from ⅛ to 1/425 of the overall area of a single partition of a first copy. In this example, the biggest component to be detected in a first copy may represent ⅛ of the overall area. The smallest component to be detected in a first copy may represent 1/425 of the overall area. The end values of that range may vary depending on the case.

By way of example, a size of an expected electronic component to be detected may be equal to or above 1 mm×0.5 mm and equal to or below 45 mm×45 mm. Therefore, three first copies may be generated having three different pixel density values. The pixel densities may be 20 pp/mm², 9 pp/mm² and 6 pp/mm². These figures may vary. For a resolution of 20 pp/mm², components smaller than 4.95 mm² may be expected to be detected. For a resolution of 9 pp/mm², components between 4.95 mm² and 24.35mm² may be expected to be detected. For a resolution of 6 pp/mm2, components larger than 24.35 mm² may be expected to be detected.

Although the detailed examples refer to electronic components, the same may be applied to printed circuit boards.

In some examples, a YOLO configuration may be fed with the first copies as described herein.

The method 700 may comprise receiving a second image of the supporting region. The second image may be captured by an overhead camera. The second image may have less definition than the first image. The expression less definition may mean a smaller number of dots per inch (DPI). In examples, the second image may fully include the supporting region.

The method 700 may comprise compensating distortion of the second image.

The method 700 may comprise identifying a high-interest region in the first image or the second image by applying a second neural network to the second image. The input of the second neural network may be a second image and the output of the second neural network may be identified high-interest regions in the second image. The first image may include at least a portion of the high-interest region. The method 700 may comprise computing a path to be followed by the head camera for capturing the identified high-interest regions. In examples, the high-interest may comprise at least one of printed circuit board, a tray, an electronic component, a fidutial mark, a feeder or a combination thereof. The high-interest regions may be characterized by coordinates of its centre of mass (x,y), the size (wide, length) and a rotation angle with respect a reference.

The method 700 may comprise scaling of the second image to a high-detail camera pixel density value.

The method 700 may comprise generating a composition of captured first images into general workspace image. The general workspace image may be the second image.

The method 700 may comprise applying a third neural network to the second image for performing an instance segmentation of elements of interest in the second image. The input of the third neural network may comprise the second image and the output may comprise segmentations of elements of interest. Elements of interest may comprise the printed circuit board and/or electronic components mounted on the board or in a tray. The segmentation may comprise generating a polygon and position the polygon over or around the elements of interest.

The method 700 may comprise determining an estimated position of fidutial marks of the printed circuit board and/or trays. These fidutial marks may be related to high-interest regions and used as references to capture a first image.

In some examples, the method 700 may comprise computing, by the controller, a layout of a printed circuit board from the output 550 of the first neural network and determining, by the controller, an operation to be performed on the printed circuit board, such as mounting an electronic component, soldering the component, unsoldering or inspecting the component. The operation may be predetermined by a user.

The method 700 may comprise training the first neural network with a set of training first images with an associated classification label. The first neural network may be trained with a set of training first copies. This way, the first neural network may be more flexible to multiple pixel density values. In each training first copy, an electronic component is classified and located for a particular pixel density value. In some examples, the same classification label may be associated to at least two different first copies. The latter may be useful to training the first neural network to detect an electronic component of the same class but different sizes in the same printed circuit board or tray.

In some examples, the second neural network may comprise a convolutional neural network.

The method 700 may comprise training the second neural network with a set of training second images with an associated classification label. The classification label of the second neural network may comprise located high-interest regions and/or position of the high-interest regions.

In some examples, the third neural network may comprise a convolutional neural network.

The method 700 may comprise training the third neural network with a set of training second images with an associated segmentation label.

According to one aspect, a method for inspecting a printed circuit board is provided. The method for inspecting comprises implementing a method for operating a multifunctional system as disclosed herein, and computing, by the controller, a layout of the printed circuit board from the output 550 of the first neural network; determining, by the controller, a test to be performed on the printed circuit board, by comparing the printed circuit board layout with pre-determined pattern layouts and associated tests; and operating, by the controller, a head assembly having an electrical probe to measure an electrical parameter or signal on an electronic component.

The electrical parameter or signal on an electronic component may be measured in response to an input signal fed to the printed circuit board.

According to a further aspect, a method for manufacturing a printed circuit board, is disclosed. The method comprises mounting electronic components stored in trays onto the printed circuit board by pick and place, by applying the method for operating the multifunctional system as disclosed herein.

The method for manufacturing a printed circuit board may comprise inspecting the printed circuit board using the method for inspecting a printed circuit board according to the examples disclosed herein.

The method for manufacturing a printed circuit board may comprise applying heat, by the heater, to the supporting region and soldering the electronic component onto the printed circuit board.

According to a yet further aspect, a method for repairing a printed circuit board is disclosed. The method comprises:
inspecting the printed circuit board using the method for inspecting a printed circuit board according to the examples disclosed herein;
identifying a faulty component based on the test of the inspection;
removing the faulty component using a head assembly.

The method for repairing a printed circuit board may comprise applying heat, by the heater, to the supporting region and unsoldering the electronic component onto the printed circuit board.

According to one aspect, a system for manufacturing a printed circuit board is disclosed. The system comprises:
a multifunctional system for electronic devices according to the examples disclosed herein;
wherein the head assembly comprises a mounting tool and the supporting region comprises a tray for receiving electronic components to be mounted, and the controller is configured to control the operation of the driving arm.

According to an aspect, a system for manufacturing a printed circuit board is disclosed.

The system may comprise:
a main frame having a receiving portion to removably receive an auxiliary frame, the auxiliary frame comprising a supporting region to support the printed circuit board;
an image sensor configured to obtain a first image of at least a portion of the supporting region;
a controller configured to receive the first image obtained by the image sensor;
a driving arm configured to drive a head assembly over the supporting region, the head assembly having a mounting tool in data communication with the controller;
wherein the controller is configured to generate a plurality of first copies of the first image wherein at least one of the first copies has a different pixel density value than the rest of the first copies, apply a manufacturing neural network for detecting electronic components based on the first copies, determining presence and location of electronic components and the printed circuit board as an output of the manufacturing neural network, and driving the head assembly to mount components on the printed circuit board by pick and place.

The manufacturing neural network may comprise the first neural network.

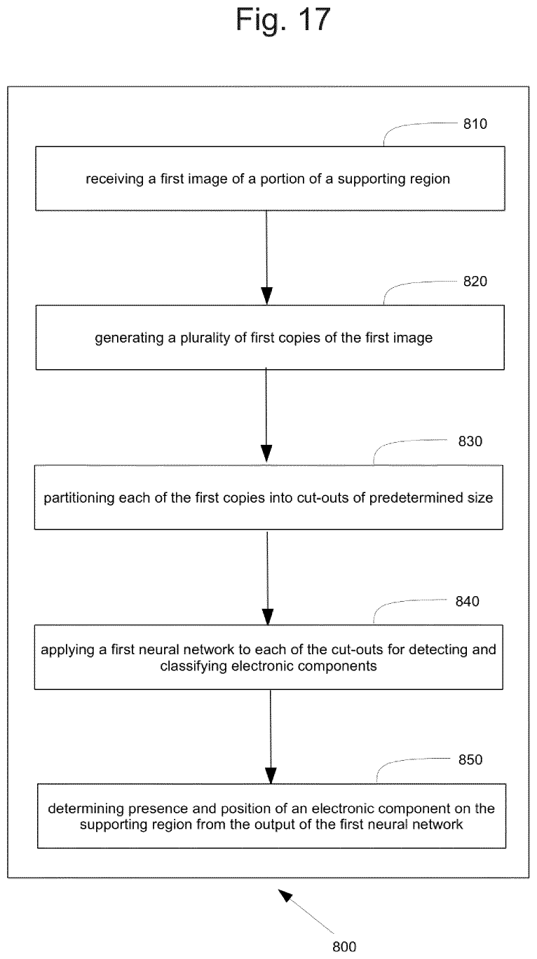

FIG. 17 is a flow chart schematically illustrating a computer-implemented method 800 according to an example of the present disclosure. The computer-implemented method 800 comprises:
receiving 810 a first image of at least a portion of a supporting region configured to support a printed circuit board and/or electronic component;
generating 820 a plurality of first copies of the first image, wherein at least one of the first copies has a different pixel density value than the rest of the first copies;
partitioning 830 each of the first copies into cut-outs of predetermined size;
applying 840 a first neural network to each of the cut-outs for detecting and classifying electronic components;
determining 850 presence and position of an electronic component on the supporting region from the output of the first neural network applied to each of the first cut-outs.

The computer-implemented method may comprise computing a layout of the printed circuit board from the output of the first neural network.

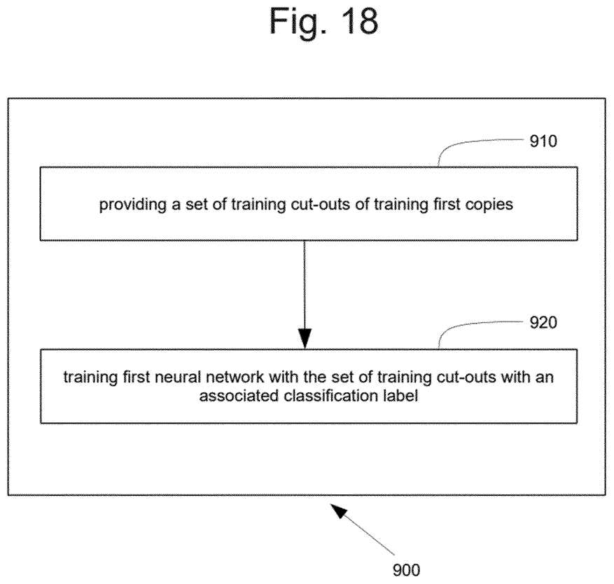

FIG. 18 is a flow chart schematically illustrating a computer-implemented method 900 according to an example of the present disclosure. The computer-implemented method 900 comprises:
providing 910 a set of training cut-outs of training first copies, wherein the training cut-outs are of a predetermined size, the size referring to a number of pixels;
training 920 the first neural network with the set of training cut-outs with an associated classification label.

According to a further aspect, a method for training a second neural network according to any of the examples herein disclosed, is disclosed. The method for training comprises:
providing a set of training second images;
training the second neural network with the set of training second images with an associated classification label, the classification label of the second neural network comprising located high-interest regions and/or position of the high-interest regions.

According to a further aspect, a method for training a third neural network according to any of the examples herein disclosed, is disclosed. The method for training comprising:
providing a set of training second copies;
training the third neural network with the set of training second images with an associated segmentation label.

According to a further aspect, a system is disclosed. The system comprises:
a receiving unit configured to receive a first image of at least a portion of a supporting region configured to support a printed circuit board and/or electronic component;
a generating unit to generate a plurality of first copies of the first image, wherein at least one of the first copies has a different pixel density value than the rest of the first copies;
a partitioning unit to partition each of the first copies into cut-outs of predetermined size;
an applying unit to apply a first neural network to each of the cut-outs for detecting and classifying electronic components;
a determining unit to determine presence and position of an electronic component on the supporting region from the output of the first neural network applied to each of the first cut-outs.

As used herein, the term “module” or “unit” may be understood to refer to software, firmware, hardware and/or various combinations thereof. It is noted that the modules are exemplary. The modules may be combined, integrated, separated, and/or duplicated to support various applications. Also, a function described herein as being performed by a particular module may be performed by one or more other modules and/or by one or more other devices instead of or in addition to the function performed by the described particular module.

The modules may be implemented across multiple devices, associated or linked to corresponding computer-implemented methods proposed herein, and/or to other components that may be local or remote to one another. Additionally, the modules may be moved from one device and added to another device, and/or may be included in both devices, associated to corresponding methods proposed herein. Any software implementations may be tangibly embodied in one or more storage media, such as e.g. a memory device, a floppy disk, a compact disk (CD), a digital versatile disk (DVD), or other devices that may store computer code.

The computer-implemented methods according to present disclosure may be implemented by computing means, electronic means or a combination thereof. The computing means may be a set of instructions (e.g. a computer program) and then methods may comprise a memory and a processor, embodying said set of instructions stored in the memory and executable by the processor. These instructions may comprise functionality or functionalities to execute corresponding methods such as e.g. the ones described with reference to other figures.

In case the computer-implemented methods are implemented only by electronic means, a controller of the system may be, for example, a CPLD (Complex Programmable Logic Device), an FPGA (Field Programmable Gate Array) or an ASIC (Application-Specific Integrated Circuit).

In case the computer-implemented methods are a combination of electronic and computing means, the computing means may be a set of instructions (e.g. a computer program) and the electronic means may be any electronic circuit capable of implementing corresponding steps of the methods proposed herein, such as those described with reference to other figures.

The computer program(s) may be embodied on a storage medium (for example, a CD-ROM, a DVD, a USB drive, a computer memory or a read-only memory) or carried on a carrier signal (for example, on an electrical or optical carrier signal).

The computer program(s) may be in the form of source code, object code, a code intermediate source and object code such as in partially compiled form, or in any other form suitable for use in implementing the computer-implemented methods according to present disclosure. The carrier may be any entity or device capable of carrying the computer program(s).

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program(s) is/are embodied in a signal that may be conveyed directly by a cable or other device or means, the carrier may be constituted by such cable or other device or means. Alternatively, the carrier may be an integrated circuit in which the computer program(s) is/are embedded, the integrated circuit being adapted for performing, or for use in the performance of, the computer-implemented methods proposed herein.

For reasons of completeness, various aspects of the present disclosure are set out in the following numbered clauses:

Clause 1. A multifunctional system for electronic devices comprising:
a main frame having a receiving portion to removably receive an auxiliary frame, the auxiliary frame comprising a supporting region to support the electronic device;
an image sensor configured to obtain a first image of at least a portion of the supporting region;
a controller configured to receive the first image obtained by the image sensor;
a driving arm configured to drive a head assembly over the supporting region, the head assembly having a tool in data communication with the controller;
   wherein the controller is configured to generate a plurality of first copies of the first image wherein at least one of the first copies has a different pixel density value than the rest of the first copies, apply a first neural network for detecting electronic components based on the first copies, and determine presence and position of an electronic component on the supporting region from the output of the first neural network.

Clause 2. The system according to clause 1, wherein the auxiliary frame comprises a dedicated device, the main frame having a main connector connectable to an auxiliary connector of the auxiliary frame, in such a way that an electrical connection is achieved between the main connector and the auxiliary connector in a coupled position of the main frame and the auxiliary frame, the dedicated device being electrically connected to the auxiliary connector.

Clause 3. The system according to clause 2, wherein the auxiliary frame has a board connector to be connected to a printed circuit board and the board connector is electrically connected to the dedicated device.

Clause 4. The system according to clause 3, wherein the dedicated device is an active testing circuit configured to feed the printed circuit board in an operation status with an input signal and to receive an output signal from the printed circuit board, and the controller is configured to control the active testing circuit.

Clause 5. The system according to any of clauses 1-4, wherein the dedicated device comprises a heater configured to apply heat to the supporting region, and the controller is configured to control the operation of the heat.

Clause 6. The system according to any of clauses 1-5, wherein the receiving portion comprises a main room to removably receive the auxiliary frame, the auxiliary frame being shaped to fit, at least partially, the main room.

Clause 7. The system according to any of clauses 1-6 wherein the driving arm comprises a linear drive.

Clause 8. The system according to any of clauses 1-7, wherein the image sensor comprises an overhead camera to capture the supporting region and a head camera to capture a portion of the supporting region.

Clause 9. The system according to any of clauses 1-8, comprising:
two driving arms, wherein the controller is configured to operate the driving arms to place the electrical probe of each driving arm on different locations of the printed circuit board.

Clause 10. The system according to any of clauses 1-9, wherein the supporting region comprises a board bed to receive the printed circuit board and a tray to receive the electronic component.

Clause 11. The system according to clause 10, wherein the tray is configured to receive electronic components randomly arranged on the tray.

Clause 12. The system according to any of clauses 1-11, wherein the portion of the supporting region includes, at least, a portion of the printed board circuit.

Clause 13. The system according to any of clauses 1-12, wherein the tool is displaceable along a Z axis and rotatable around Z axis.

Clause 14. The system according to any of clauses 1-13, wherein the head assembly comprises a mounting tool configured to mount an electronic component, the mounting tool being in data communication with the controller.

Clause 15. The system according to clause 14, wherein the mounting tool comprises a suction tool to carry an electronic component.

Clause 16. The system according to any of clauses 14-15, wherein the mounting tool comprises a soldering tool to solder an electronic component onto the printed circuit board.

Clause 17. The system according to any of clauses 1-16, wherein the head assembly comprises a thermal sensor configured to capture thermal images of the supporting region, the thermal sensor being in data communication with the controller.

Clause 18. The system according to clause 7, comprising:
two guiding rails parallel to each other, and each end of the linear drive is slidably connected to each guiding rail.

Clause 19. The system according to any of clauses 1-18, wherein the first neural network comprises a convolutional neural network.

Clause 20. The system according to any of clauses 1-19, wherein the first neural network is trained using training first copies with an associated classification label.

Clause 21. A method for operating a multifunctional system for electronic device, comprising:
capturing, by an image sensor, a first image of at least a portion of a supporting region configured to support the electronic device;
generating, by a controller, a plurality of first copies of the first image, wherein at least one of the first copies has a different pixel density value than the rest of the first copies;
partitioning, by the controller, each of the first copies into cut-outs of predetermined size;
applying, by the controller, a first neural network to each of the cut-outs for detecting and classifying electronic components;
determining, by the controller, presence and position of an electronic component on the supporting region from the output of the first neural network applied to each of the first cut-outs.

Clause 22. The method according to clause 21, comprising:
adjusting the pixel density value of a first copy based on a size of an expected electronic component to be detected.

Clause 23. The method according to any of clauses 21-22, comprising: adjusting the pixel density value of a first copy in such a way that the size of the expected electronic component to be detected is within the range from ⅛ to 1/425 of the overall area of a single partition of a first copy.

Clause 24. The method according to any of clauses 22-23, wherein the size of the component is related to the area occupied by the component seen from above.

Clause 25. The method according to any of clauses 21-24, wherein the first image is captured such that a predetermined distance is defined from an image sensor to the supporting region.

Clause 26. The method according to any of clauses 21-25, comprising:
receiving a second image of the supporting region.

Clause 27. The method according to clause 26, wherein the second image has less definition than the first image.

Clause 28. The method according to clause 26, wherein the second image fully includes the supporting region.

Clause 29. The method according to clause 26, wherein the second image is captured by an overhead camera.

Clause 30. The method according to any of clauses 26-29, comprising:
compensating, by the controller, distortion of the second image.

Clause 31. The method according to any of clauses 26-30, comprising:
identifying, by the controller, a high-interest region in the first image or the second image by applying a second neural network to the second image, the high-interest comprising at least one of printed circuit board, a tray, an electronic component, a fidutial mark, a feeder or a combination thereof.

Clause 32. The method according to clause 31, wherein the first image includes at least a portion of the high-interest region.

Clause 33. The method according to any of clauses 26-32, comprising:
scaling of the second image to the high-detail camera pixel density.

Clause 34. The method according to any of clauses 31-32, comprising:
computing, by the controller, a path to be followed by a head camera of the head assembly for capturing the identified high-interest regions.

Clause 35. The method according to any of clauses 31-32, comprising:
generating, by the controller, a composition of captured images into general workspace image.

Clause 36. The method according to any of clauses 26-35, comprising:
applying, by the controller, a third neural network to the second image for performing an instance segmentation of interest elements in the second image.

Clause 37. The method according to clause 36, comprising:
determining an estimated position of fidutial marks of the printed circuit board and/or trays.

Clause 38. The method according to any of clauses 21-37, comprising:
training the first neural network with a set of training first images with an associated classification label.

Clause 39. The method according to any of clauses 21-38, wherein the first neural network is trained with a set of training first copies with an associated classification label.

Clause 40. A method for training a first neural network of a method for operating a multifunctional system for electronic devices according to any of clauses 21-39, the method for training comprising:
providing a set of training cut-outs of training first copies, wherein the training cut-outs are of a predetermined size, the size referring to a number of pixels;
training the first neural network with the set of training cut-outs with an associated classification label.

Clause 41. A method for training a second neural network of a method for operating a multifunctional system for electronic devices according to any of clauses 31-32, the method for training comprising:
providing a set of training second images;
training the second neural network with the set of training second images with an associated classification label, the classification label of the second neural network comprising located high-interest regions and/or position of the high-interest regions.

Clause 42. A method for training a third neural network of a method for operating a multifunctional system for electronic devices according to any of clauses 36-37, the method for training comprising:
providing a set of training second copies;
training the third neural network with the set of training second images with an associated segmentation label.

Clause 43. A method for inspecting a printed circuit board, comprising:
implementing a method for operating a multifunctional system according to any of clauses 21-39;
computing, by the controller, a layout of the printed circuit board from the output of the first neural network;
determining, by the controller, a test to be performed on the printed circuit board, by comparing the printed circuit board layout with pre-determined pattern layouts and associated tests;
operating, by the controller, a head assembly having an electrical probe to measure an electrical parameter or signal on an electronic component.

Clause 44. The method according to clause 43, wherein the electrical parameter or signal on an electronic component is measured in response to an input signal fed to the printed circuit board.

Clause 45. A method for manufacturing a printed circuit board comprising:
mounting electronic components stored in trays onto the printed circuit board by pick and place;
inspecting the printed circuit board using the method for inspecting a printed circuit board according to any of clauses 43-44.

Clause 46. The method according to clause 45, comprising:
applying heat, by the heater, to the supporting region and soldering the electronic component onto the printed circuit board.

Clause 47. A method for repairing a printed circuit board comprising:
inspecting the printed circuit board using the method for inspecting a printed circuit board according to any of clauses 43-44,
identifying, by the controller, a faulty component based on the test of the inspection,
removing the faulty component using a head assembly.

Clause 48. The method according to clause 47, comprising:
applying heat, by the heater, to the supporting region and unsoldering the electronic component onto the printed circuit board.

Clause 49. A computer-implemented method comprising:
receiving a first image of at least a portion of a supporting region configured to support a printed circuit board and/or electronic component;
generating a plurality of first copies of the first image, wherein at least one of the first copies has a different pixel density value than the rest of the first copies;
partitioning each of the first copies into cut-outs of predetermined size;
applying a first neural network to each of the cut-outs for detecting and classifying electronic components;
determining presence and position of an electronic component on the supporting region from the output of the first neural network applied to each of the first cut-outs.

Clause 50. The method of clause 49, comprising:
computing a layout of the printed circuit board from the output of the first neural network.

Clause 51. A system for inspecting a printed circuit board, comprising:
a multifunctional system according to any of clauses 1-20, wherein the head assembly comprises an electrical probe, and the controller is configured to compute a layout of the printed circuit board from an output of the first neural network and determine a test to be performed on the printed circuit board by comparing the layout of the printed circuit board with pre-determined layouts and associated tests.

Clause 52. A system comprising:
a receiving unit configured to receive a first image of at least a portion of a supporting region configured to support a printed circuit board and/or electronic component;
a generating unit to generate a plurality of first copies of the first image, wherein at least one of the first copies has a different pixel density value than the rest of the first copies;
a partitioning unit to partition each of the first copies into cut-outs of predetermined size;
an applying unit to apply a first neural network to each of the cut-outs for detecting and classifying electronic components;
a determining unit to determine presence and position of an electronic component on the supporting region from the output of the first neural network applied to each of the first cut-outs.

Clause 53. A system for manufacturing a printed circuit board comprising:
a system for inspecting a printed circuit board according to clause 51;
wherein the head assembly comprises a mounting tool and the supporting region comprises a tray for receiving electronic components to be mounted, and the controller is configured to control the operation of the driving arm.

Clause 54. A system for manufacturing a printed circuit board comprising:
a main frame having a receiving portion to removably receive an auxiliary frame, the auxiliary frame comprising a supporting region to support the printed circuit board;
an image sensor configured to obtain a first image of at least a portion of the supporting region;
a controller configured to receive the first image obtained by the image sensor;
a driving arm configured to drive a head assembly over the supporting region, the head assembly having a mounting tool in data communication with the controller;
wherein the controller is configured to generate a plurality of first copies of the first image wherein at least one of the first copies has a different pixel density value than the rest of the first copies, apply a manufacturing neural network for detecting electronic components based on the first copies, determining presence and location of electronic components and the printed circuit board as an output of the manufacturing neural network, and driving the head assembly to mount components on the printed circuit board by pick and place.

Clause 55. Computer program comprising program instructions for causing a computer or system to perform a method according to clause 49.

Clause 56. Computer program according to clause 55, embodied on a storage medium or carried on a carrier signal.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

What is claimed is:

1-46. (canceled)

47. A multifunctional system for electronic devices comprising:
a main frame having a receiving portion to removably receive an auxiliary frame, the auxiliary frame comprising a supporting region to support the electronic device;
an image sensor to obtain a first image of at least a portion of the supporting region;
a controller to receive the first image obtained by the image sensor;
a driving arm to drive a head assembly over the supporting region, the head assembly having a tool in data communication with the controller;
wherein the controller is to generate a plurality of first copies of the first image wherein at least one of the first copies has a different pixel density value than the rest of the first copies, partition each of the first copies into cut-outs of a predetermined size, the size referring to a number of pixels, apply a first neural network to each of the cut-outs for detecting electronic components, and determine presence and position of an electronic component on the supporting region from the output of the first neural network.

48. The system according to claim 47, wherein the auxiliary frame comprises a dedicated device, the main frame having a main connector connectable to an auxiliary connector of the auxiliary frame, in such a way that an electrical connection is achieved between the main connector and the auxiliary connector in a coupled position of the main frame and the auxiliary frame, the dedicated device being electrically connected to the auxiliary connector.

49. The system according to claim 48, wherein the auxiliary frame has a board connector to be connected to a printed circuit board and the board connector is electrically connected to the dedicated device.

50. The system according to claim 49, wherein the dedicated device is an active testing circuit configured to feed the printed circuit board in an operation status with an input signal and to receive an output signal from the printed circuit board, and the controller is configured to control the active testing circuit.

51. The system according to claim 47, wherein the supporting region comprises a board bed to receive a printed circuit board and a tray to receive the electronic component.

52. The system according to claim 51, wherein the tray is configured to receive electronic components randomly arranged on the tray.

53. The system according to claim 47, wherein the portion of the supporting region includes, at least, a portion of the printed board circuit.

54. The system according to claim 47, wherein the head assembly comprises a mounting tool configured to mount an electronic component, the mounting tool being in data communication with the controller.

55. The system according to claim 47, wherein the head assembly comprises an electrical probe, and the controller is to compute a layout of a printed circuit board from an output of the first neural network and determine a test to be performed on the printed circuit board by comparing the layout of the printed circuit board with pre-determined layouts and associated tests.

56. The system according to claim 55, wherein the head assembly comprises a mounting tool and the supporting region comprises a tray for receiving electronic components to be mounted, and the controller is configured to control the operation of the driving arm.

57. A method for operating a multifunctional system for electronic device, comprising:
capturing, by an image sensor, a first image of at least a portion of a supporting region configured to support the electronic device;
generating, by a controller, a plurality of first copies of the first image, wherein at least one of the first copies has a different pixel density value than the rest of the first copies;
partitioning, by the controller, each of the first copies into cut-outs of predetermined size, the size referring to a number of pixels;
applying, by the controller, a first neural network to each of the cut-outs for detecting and classifying electronic components;
determining, by the controller, presence and position of an electronic component on the supporting region from the output of the first neural network applied to each of the first cut-outs.

58. The method according to claim 57, comprising:
adjusting the pixel density value of a first copy based on a size of an expected electronic component to be detected.

59. The method according to claim 57, comprising:
adjusting the pixel density value of a first copy in such a way that the size of the expected electronic component to be detected is within the range from ⅛ to 1/425 of the overall area of a single partition of a first copy.

60. The method according to claim 57, comprising:
receiving, by the controller, a second image of the supporting region;
identifying, by the controller, a high-interest region in the first image or the second image by applying a second neural network to the second image, the high-interest comprising at least one of printed circuit board, a tray, an electronic component, a fidutial mark, a feeder or a combination thereof.

61. The method according to claim 60, comprising:
computing, by the controller, a path to be followed by a head camera of the head assembly for capturing the identified high-interest regions.

62. The method according to claim 60, comprising:
generating, by the controller, a composition of captured images into general workspace image.

63. The method according to claim 57, comprising:
providing a set of training cut-outs of training first copies, wherein the training cut-outs are of a predetermined size, the size referring to a number of pixels;
training the first neural network with the set of training cut-outs with an associated classification label.

64. The method according to claim 57, comprising:
computing, by the controller, a layout of a printed circuit board from the output of the first neural network;
determining, by the controller, a test to be performed on the printed circuit board, by comparing the printed circuit board layout with pre-determined pattern layouts and associated tests;
operating, by the controller, a head assembly having an electrical probe to measure an electrical parameter or signal on an electronic component.

65. The method according to claim 64, comprising:
driving the head assembly to mount electronic components stored in trays onto the printed circuit board by pick and place.

66. A system comprising a processor and a memory containing instructions which, when executed by the processor, perform the following:
receiving a first image of at least a portion of a supporting region configured to support a printed circuit board and/or electronic component;
generating a plurality of first copies of the first image, wherein at least one of the first copies has a different pixel density value than the rest of the first copies;
partitioning each of the first copies into cut-outs of predetermined size, the size referring to a number of pixels;
applying a first neural network to each of the cut-outs for detecting and classifying electronic components;
determining presence and position of an electronic component on the supporting region from the output of the first neural network applied to each of the first cut-outs.
